(19) United States
(12) Patent Application Publication
(10) Pub. No.: US 2005/0044261 A1
(43) Pub. Date: Feb. 24, 2005

(54) Method of operating a network switch

(76) Inventor: Rahul Saxena, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/622,287

(22) Filed: Jul. 18, 2003

(51) Int. Cl. G06F 15/16

(52) U.S. Cl. 709/236; 709/246; 709/238

(57) ABSTRACT

Numerous embodiments of a method of operating a network switch are disclosed. In one embodiment, such a method comprises receiving electronic data on a first port of a data networking device, deleting at least a portion of the electronic data prior to providing the electronic data to the memory of the data networking device, and modifying the electronic data prior to providing at least a portion of the electronic data to a second port.

### BACKGROUND

Data networking devices, such as switches and routers, for example, may use a store and forward mechanism to route electronic data across a network. Devices such as these may have multiple ports, and all the ports may share a common memory. This shared memory may have a limited capacity, and may also have a limited bus width. It may be desirable to develop a method of improving the memory bandwidth utilization for devices such as these.

### BRIEF DESCRIPTION OF THE DRAWINGS

The subject matter regarded as particular embodiments is particularly pointed out and distinctly claimed in the concluding portion of the specification. Embodiments of the claimed subject matter, however, both as to organization and method of operation, together with objects, features, and advantages thereof, may best be understood by reference to the following detailed description when read with the accompanying drawings in which:

FIG. 1 illustrates a block diagram of a data networking device and particular functions in accordance with at least one embodiment;

FIG. 2 illustrates a block diagram of functions of a data networking device and particular functions, as may be known in the art; and

FIG. 3 is a block diagram of a system which may incorporate one or more of the functions of a data networking device in accordance with at least one embodiment.

### DETAILED DESCRIPTION

Embodiments of the claimed subject matter may comprise a method for operating a data networking device. In one embodiment, such a method comprises receiving electronic data on a first port of a data networking device, deleting at least a portion of the electronic data prior to providing the electronic data to the memory of the data networking device, and modifying the electronic data prior to providing at least a portion of the electronic data to a second port.

As mentioned previously, data networking devices may use a store and forward mechanism to route electronic data. Data networking devices may include, for example, high speed Ethernet switches, Ethernet Layer 2 or Layer 3 switches, bridges or routers, for example. Devices such as these may be capable of sending and/or receiving electronic data in the form of contiguous or non contiguous blocks of data, which may comprise packets or frames, for example. As is well known, a block of electronic data may be encapsulated, or have a header added to it, creating a data segment. The data segment may be further encapsulated by adding additional header information, in order to create a datagram. A datagram, which may also be referred to as a packet, may comprise at least a portion of a frame, and a frame may comprise one or more datagrams plus additional header information. Electronic data suitable for routing across a network may therefore contain one or more headers and a payload, where the payload includes the original contiguous data segment. In the following embodiments, electronic data blocks may be referred to as frames, but it is important to note that this is for illustrative purposes only, and the claimed subject matter is not so limited. A Frame, in this context, may be used to describe any contiguous data segment capable of being transmitted and/or received by a data networking device or over a network.

The header of encapsulated electronic data such as a frame typically includes fields such as the source address of the device sending the frame, length data, destination address, as well as payload data. Electronic data suitable for transmission across a network typically complies with a particular data protocol, such as the Ethernet protocol as defined by the Institute for Electrical and Electronics Engineers (IEEE) standard 802.3, 2000 edition (“Ethernet Specification”), available from IEEE standards, 445 Hoes Lane, P.O. Box 1331, Piscataway, N.J., 08855-1331. Additional information may be found on the World Wide Web at the following URL: http://www.ieee.org.

As stated previously, data networking devices may operate by use of shared memory, which may also referred to as a frame buffer, in the context of a network switch. In this context, shared memory refers to the common memory used for temporary storage of electronic data sent and/or received by one or more of the ports of a device. In devices such as these, a frame may be stored until a transmission port is available to transmit the frame, for example, and these types of devices may be referred to as store-and-forward (SAF) switches. For example, a sixteen port SAF switch may have a shared memory, where at least a portion of the frames sent and/or received on the sixteen ports may be stored for a particular period of time on the shared memory, which may comprise one or more queues, for example. However, devices in accordance with one or more embodiments may have additional memory not shared amongst all ports, or may have separate memory for individual ports, for example, and may additionally have a plurality of transmit and/or receive ports, and remain in accordance with at least one embodiment.

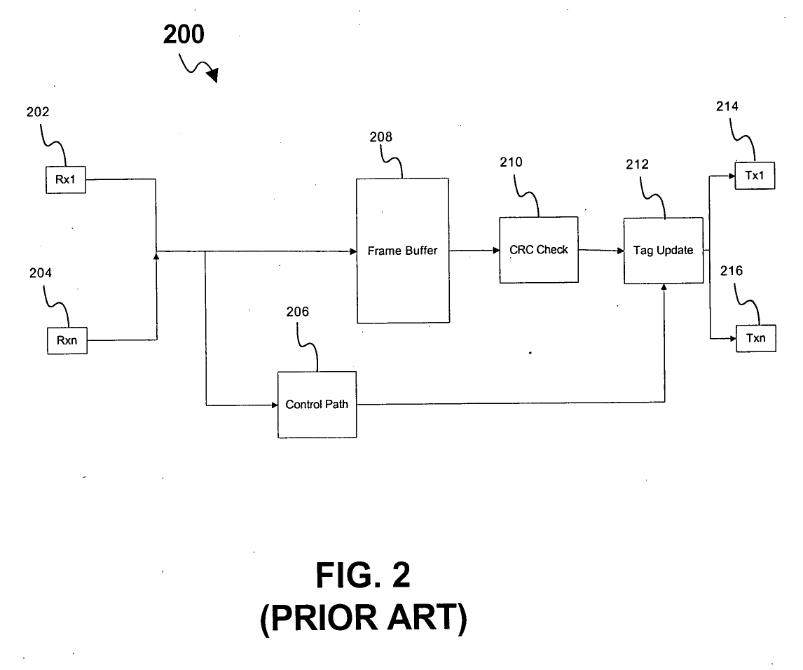

Referring now in detail to the drawings wherein like parts are designated by like reference numerals throughout, there is illustrated in FIG. 2 particular functions of a conventional shared memory based data networking device, such as a switch or router, for example. In operation, a frame (not shown) may be received by a port, such as port 202 or 204, which, in this figure, illustrate one or more receive ports Rx1-Rxn of a device. The frame may then transmitted to the shared memory, illustrated as frame buffer 208, where it is stored until a routing determination may be made. A copy of a portion of the frame containing routing information, such as the protocol header, may be transmitted to the control path functional block 206, and may comprise the first 64 bytes, for example. The protocol header may contain a variety of information relating to routing and/or priority, such as a VLAN tag (virtual local area network), for example. Control path functional block 206 may read at least a portion of the bytes contained in the protocol header, and determine if the frame should be routed to transmission port 214 or 216, for example, which, in this figure, illustrate one or more transmit ports Tx1-Txn of a device. Additionally, control path functional block 206 may make determinations such as whether to edit the frame, which may include updating the VLAN tag (typically a 16 bit tag), which may comprise stripping the tag, or modifying the tag with a VLAN tag corresponding with the egress VLAN of the routed frame, for example. VLAN tags, as is well known, are typically used within a virtual local area network, and may be used when a single bridge joins several functional networks, for example. VLAN tags may be inserted following the destination address of a frame, for example, and may contain routing and/or priority information for a frame.

After control path functional block 206 makes a determination of which port to route the frame, the frame is read from the frame buffer, and a CRC (cyclic redundancy code) check 210 may be performed. This check is an error checking system, and is typically a 32 bit system, wherein an error checking bit may be inserted to a frame prior to transmission to verify an error free receipt by a device such as a switch, for example. If CRC check 210 fails, the frame may be discarded, for example. If the CRC check 210 passes, the frame is forwarded to one of the ports 214 or 216, depending on the routing information read by the control path, and the routing determination made by the control path. Prior to receipt for transmission by one of the ports, a Tag update 212 may be performed on the frame, and may include the aforementioned VLAN tag stripping or deletion, in the case where the outgoing network doesn't recognize tags, for example, or may comprise replacement of the tag with a differing VLAN tag, where the VLAN tag replacing the existing tag may be supplied by the control path functional block 206. As shown in this device, the entire frame is typically stored in the buffer memory, and may result in the storage of more data than is required for adequate operation of the data networking device, for example.

It is worthy to note that any reference in the specification to “one embodiment” or “an embodiment” means that a particular feature, structure, or characteristic described in connection with the embodiment is included in at least one embodiment of the claimed subject matter. The appearances of the phrase “in one embodiment” in various places in the specification are not necessarily all referring to the same embodiment.

Numerous specific details may be set forth herein to provide a thorough understanding of embodiments of the claimed subject matter. It will be understood by those skilled in the art, however, that certain embodiments may be practiced without these specific details. In other instances, well-known methods, procedures and components have not been described in detail so as not to obscure the embodiments of the claimed subject matter. It can be appreciated that the specific structural and functional details disclosed herein may be representative and do not necessarily limit the scope of the claimed subject matter.

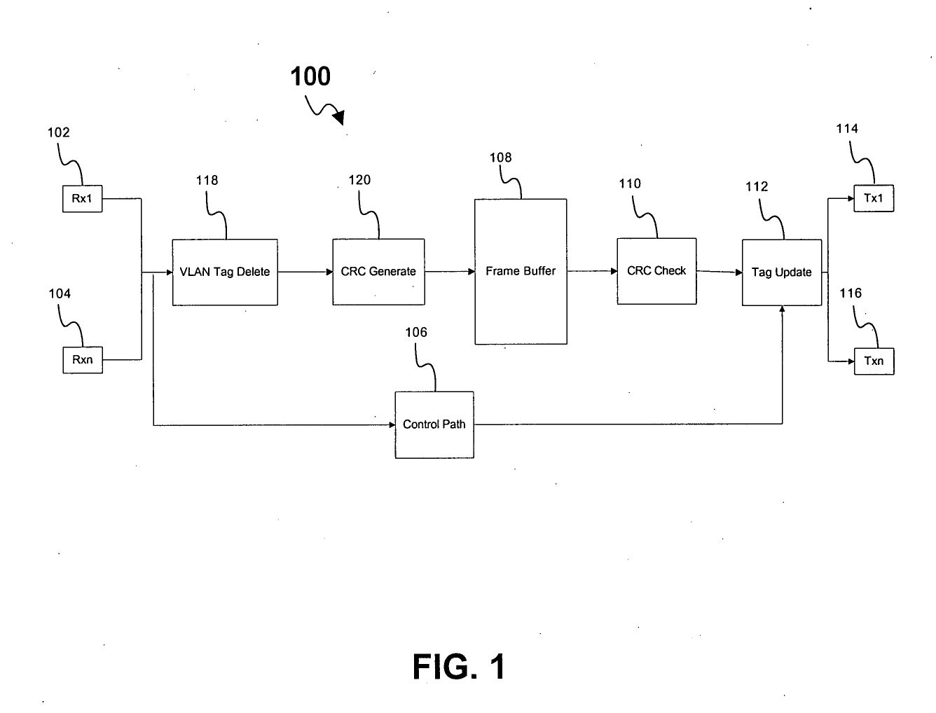

Illustrated in FIG. 1 is a functional block diagram of a shared memory based data networking device in accordance with one embodiment of the claimed subject matter. Illustrated in FIG. 1 is a data networking device functional block diagram, that may include, for example, an Ethernet switch, a router, or one or more other types of networking devices capable of sending, routing, and/or receiving network data. The particular functions illustrated in FIG. 1 may be used to substantially perform particular embodiments, although the functions are not limited in this respect, and the order in which the functional blocks are presented do not necessarily limit the claimed subject matter to any particular order, and several intervening functional blocks may be used within the scope of the claimed subject matter. Additionally, several functions of a device such as illustrated may not be shown or described in detail, but several additionally functions may be capable of being performed by devices such as these. One or more processors of a data networking device may perform one or more of the functions disclosed herein, although the claimed subject matter is not so limited.

FIG. 1 comprises a device with a plurality of receive ports Rx1-Rxn and transmit ports Tx1-Txn, represented here by receive ports 102 and 104 and transmit ports 114 and 116, a shared memory illustrated as frame buffer 108, a VLAN tag delete functional block 118, a CRC generate functional block 120, a CRC check functional block 110, a tag insert functional block 112, and a control path functional block 106. Although illustrated as a particular configuration, it is important to note that the claimed subject matter is not so limited. For example, a data networking device containing more or less than two receive ports and two transmit ports is in accordance with at least one embodiment.

In operation, the functions of data networking device 100 may perform in the following manner, although this is an exemplary embodiment, and numerous variations and intermediate functions may be used and remain in accordance with the claimed subject matter. Electronic data, such as a frame, may be received by one or more ports 102 and 104, although electronic data may comprise other configurations, and may depend at least in part on the type of networking device performing the functions disclosed herein.

After receipt by a port of the device 100, if the data received comprises a frame, the frame (not shown) may be transmitted to the VLAN tag delete functional block 118. Functional block 118 may operate to delete at least a portion of the VLAN tag contained in the frame, for example, if there is a VLAN tag contained in the frame. In one embodiment, the entire VLAN tag may be deleted from the frame. After functions of block 118 are performed on the frame, causing at least a portion of the VLAN tag to be deleted from the frame by the VLAN tag delete functional block 118, the remaining frame may be transmitted to the CRC generate functional block 120. Block 120 may operate to generate a CRC for the frame, and may additionally replace the generated CRC over the existing CRC field of the frame. This function may be performed if the VLAN tag was deleted, for example, and if the VLAN tag was deleted and a new CRC field was not generated, the CRC check may fail during the check function of the switch.

At least a portion of the frame, including information such as a header, or other control information that may be used by to route or determine routing of the frame, may be transmitted to the control path functional block 106, and this may be performed prior to providing the frame to the VLAN tag deleted functional block 118, for example. Control path functional block 106 may, based at least in part on the portion of the frame transmitted to block 106, determine which transmit port, 114 or 116, to transmit the frame stored in frame buffer 108. Additionally, block 106 may make a determination of whether to edit the frame, which may include determining the value of the VLAN tag to be inserted into the frame prior to transmission, as described previously.

At least a portion of the remaining frame may then be provided from the CRC generate block 120 to the frame buffer 108. The frame provided by block 120 may be stored in frame buffer 108, which may comprise one or more memory devices, and may be internal or external memory of the networking device, depending on the particular type of device executing the functions. The frame buffer may have a particular bus width, such as a 64 byte bus width, and may have a limited bandwidth, due at least in part to the bus width. As stated previously, the memory may comprise one or more queues, and may be segmented into memory segments associated with particular ports, although the claimed subject matter is not so limited. The memory may serve as a temporary memory for one or more of the ports of the networking device, and may store data in addition to frames in the process of being routed, such as information relating to functionality of the device, for example.

After a route is determined by the control path 106, the frame buffer may transmit at least a portion of the frame stored in the frame buffer to the CRC check functional block 110. This functional block may operate to check the CRC field, which may be a check of the CRC generated by functional block 120, for example. If the frame passes the CRC check of block 110, the frame may be transmitted to the tag update functional block 112. The tag update block may operate to insert a VLAN tag, and may be the same VLAN tag deleted by functional block 118, if, for example, control path 106 makes a determination to not edit the frame header. However, if a determination is made to edit the VLAN tag, a new VLAN tag, which may represent the VLAN for the transmit port determined to be the proper routing port by control path 106, may be inserted. Alternatively, if attributes of the outgoing network are such that the network does not recognize or utilize tags, tag update block 112 may not insert a tag, and the frame may be transmitted to the transmit port without a tag, and the tag update block may not perform any functions on the outgoing frame. After the tag insert functional block performs one or more of the above-described functions, the frame may be then transmitted to the transmit port determined by control path 106.

As shown in this embodiment, if the VLAN tag is removed from a frame prior to storing the frame in the frame buffer, the amount of data stored in the frame buffer may comprise less than the entire frame received on one or more of the receive ports. This may result in reduction in usage of the frame buffer as compared to conventional networking devices. Additionally, if the frame buffer has a limited bandwidth, such as a 64 byte wide bus, this may result in a reduction in usage of the memory bus, resulting in increased available bandwidth, which may be used for storing other frames, or for performing other functions of the networking device, for example.

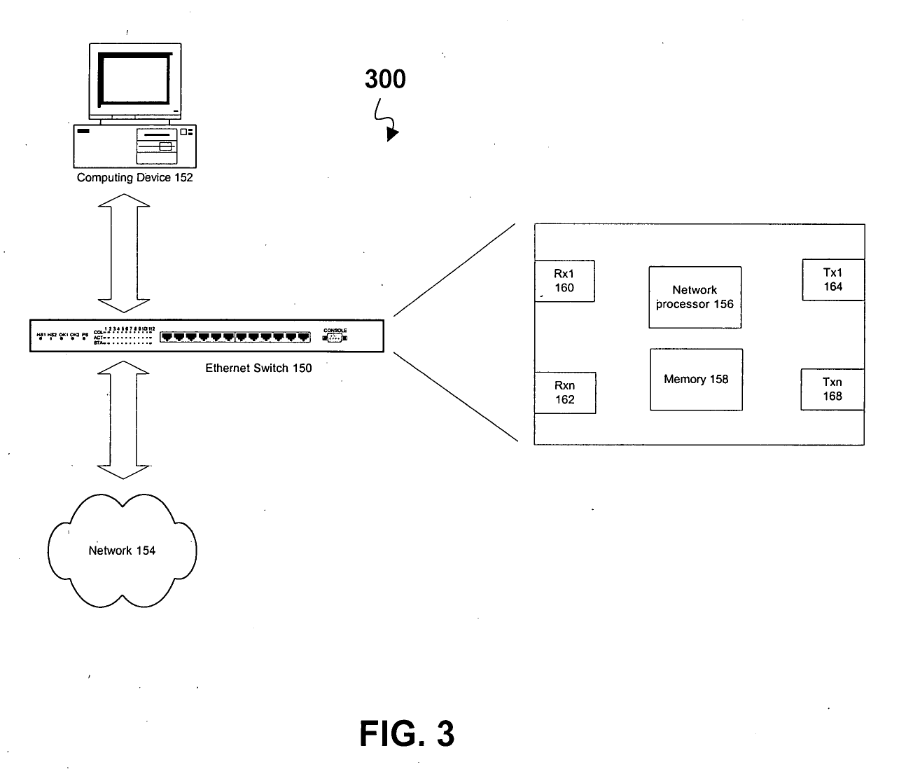

Illustrated in FIG. 3 is a system incorporating a switch, which may operate in accordance with one or more of the embodiments disclosed herein. Illustrated in FIG. 3 is system 300, comprising a computing device 152, an Ethernet switch 150, and a network 154. In this configuration, computing device may be capable of sending to and/or receiving from network 154 electronic data, such as frames, for example. Computing device 152 is intended to represent a range of computing devices such as personal computers, laptop computers, personal digital assistants (PDAs), laptop computers, portable phones or other like devices. Computing device may, depending on the particular type of device, include memory, such as random access memory or read only memory, one or more processors, one or more types of data storage, and one or more types of input/output devices and/or user interfaces. Computing device 152 may be capable of communicating with Ethernet switch by use of communication media (not shown). Ethernet switch 150 may be capable of sending, routing and/or receiving data from the computing device 152 and network 154, for example. Ethernet switch may be configured to implement one or more of the functions disclosed herein, by use of one or more of the components as illustrated, for example. Ethernet switch 150 may comprise one or more receive ports, such as ports 160 and 162, and one or more transmit ports, such as 164 and 168, which may be capable of sending and/or receiving electronic data such as frames, but it is important to note that devices used in accordance with one or more embodiments are not limited to any particular number of transmit and/or receive ports. Ethernet switch may additionally comprise a processor 156, which may comprise a network processor, such as an® 1×P2800 based network processor or an ASIC (Application Specific Integrated Circuit) processor, for example. Additionally, Ethernet switch 150 and may comprise one or more types of memory 158, which may comprise random access and/or read only memory, which may comprise, for example, Synchronous Dynamic Random Access Memory (SDRAM) or Static Random Access Memory (SRAM), for example. Processor 156 may be operative to perform one or more of the functions disclosed in reference to FIG. 1, fore example. Ethernet switch may be configured to communicate with computing device 152 and network 154, for example. Network 154 may comprise a plurality of computing devices, and may comprise a local area network (LAN), a wide area network (WAN), or a wireless wide area network (WWAN) as just a few examples.

It can be appreciated that the embodiments may be applied methods of operating data networking devices. Certain features of the embodiments of the claimed subject matter have been illustrated as described herein, however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still remain in accordance with the claimed subject matter. It is, therefore, to be understood that the appended claims are intended to cover all such modifications and changes as fall within the true spirit of the embodiments of the claimed subject matter.

1. A method of operating a network device, comprising:
receiving electronic data from a first port of the data networking device;
deleting at least a portion of the electronic data prior to providing the electronic data to the memory of the networking device;
providing at least a portion of the electronic data to a second port.

2. The method of claim 1, further comprising modifying the electronic data prior to said providing.

3. The method of claim 1, wherein the electronic data comprise a frame.

4. The method of claim 1, wherein the portion of electronic data deleted comprises a VLAN (virtual local area network) tag.

5. The method of claim 3, wherein modifying comprises inserting a VLAN tag to the frame.

6. The method of claim 3, further comprising generating a CRC (cyclic redundancy code) and inserting the CRC into the frame prior to providing to the memory.

7. The method of claim 1, further comprising providing a portion of the electronic data to a control module prior to deleting a portion of the electronic data.

8. The method of claim 7, wherein the portion of data provided to the control module comprises the protocol header.

9. The method of claim 1, wherein the first port and the second port comprise a receive port and a transmit port, respectively.

10. An apparatus, comprising:
one or more receive ports capable of receiving electronic data from a network;
one or more transmit ports capable of transmitting electronic data to a network;
a memory; and
a processor, the processor configured to, in operation:
delete at least a portion of the electronic data received by the one or more receive ports;
provide the remaining electronic data to the memory;
read the electronic data from the memory;
modify the electronic data after reading from the memory; and
provide at least a portion of the electronic data to one or more of the transmit ports.

11. The apparatus of claim 10, wherein the processor is further configured to modify the electronic data prior to providing at least a portion of the electronic data to one or more of the transmit ports.

12. The apparatus of claim 10, wherein the apparatus comprises a network switch.

13. The apparatus of claim 12, wherein said memory comprises network switch internal memory.

14. The apparatus of claim 10, wherein said portion of electronic data deleted substantially comprises a VLAN tag.

15. The apparatus of claim 11, wherein modifying the electronic data comprises inserting a VLAN tag, wherein the VLAN tag relates at least in part to the destination address of the electronic data.

16. The apparatus of claim 10, wherein the processor comprises a network processor.

17. The apparatus of claim 10, wherein the memory comprises a plurality of memory devices.

18. The apparatus of claim 17, wherein the plurality of memory devices comprise one or more of: random access memory, static random access memory, and synchronous dynamic random access memory.

19. A system for network data communication, comprising:
a first port to receive electronic data from a network;
a second port to transmit electronic data to a network;
a memory to store electronic data; and
a processor coupled to the first port, second port, and the memory, wherein the processor is configured to, in operation, delete at least a portion of electronic data received on a first port, provide at least a portion of the electronic data to the memory, and modify the electronic data prior to providing at least a portion of the electronic data to the second port.

20. The system of claim 19, wherein the electronic data comprise a frame.

21. The system of claim 19, wherein the portion of electronic data deleted comprises a VLAN (virtual local area network) tag.

22. The system of claim 20, further comprising generating a CRC (cyclic redundancy code) and inserting the CRC into the frame prior to providing to the memory.

23. The system of claim 19, wherein modifying the electronic data comprises inserting a VLAN tag, wherein the VLAN tag relates at least in part to the destination address of the electronic data.

24. The system of claim 19, wherein the processor comprises a network processor.

25. The system of claim 19, wherein the memory comprises a plurality of memory devices.

26. The system of claim 25, wherein the plurality of memory devices comprise one or more of: random access memory, static random access memory, and synchronous dynamic random access memory.

27. The system of claim 19, wherein said processor is configured to modify said electronic data only if said second port is configured to recognize tags.
